(19) United States
(12) Patent Application Publication
(10) Pub. No.: US 2006/0214814 A1
(43) Pub. Date: Sep. 28, 2006

(54) WELLBORE COMMUNICATION SYSTEM

(75) Inventors: STEVEN J. PRINGNITZ, SUGAR LANE, TX (US); BRIAN E. BOLING, SUGAR LANE, TX (US); RICHARD E. THORP, RICHMOND, TX (US)

Correspondence Address: SCHLUMBERGER OILFIELD SERVICES, 200 GILLINGHAM LANE, MD 200-9, SUGAR LAND, TX, 77478, US

(73) Assignee: SCHLUMBERGER TECHNOLOGY CORPORATION, SUGAR LAND, TX (US)

(21) Appl. No.: 11/308,026

(22) Filed: Mar. 3, 2006

Related U.S. Application Data
(60) Provisional application No. 60/594,273, filed on Mar. 24, 2005.

(51) Int. Cl. G01V 3/00

(52) U.S. Cl. 340/855.4

(57) ABSTRACT

A telemetry system for a downhole tool positionable in a wellbore penetrating a subterranean formation is provided. The telemetry system includes a telemetry tool engageable within the downhole tool. The telemetry tool including a telemetry unit, the unit being interchangeable between a mud pulse telemetry unit and an electromagnetic telemetry unit.

### CROSS-REFERENCES

The present application claims priority of U.S. Provisional Patent Application Ser. No. 60/594,273 filed on Mar. 24, 2005. The Provisional Application is incorporated by reference in its entirety.

### BACKGROUND OF THE INVENTION

The present invention relates to the exploration/production of a subterranean formation penetrated by a wellbore. More particularly, the present invention relates to techniques for communicating between equipment at the surface, and a downhole tool positioned in the wellbore.

The exploration and production of hydrocarbons involves placement of a downhole tool into the wellbore to perform various downhole operations. There are many types of downhole tools used in hydrocarbon reservoir exploration/production. Typically, a drilling tool is suspended from an oil rig and advanced into the earth to form the wellbore. The drilling tool may be a measurement-while-drilling (MWD) or a logging-while-drilling (LWD) tool adapted to perform downhole operations, such as taking measurements, during the drilling process. Such measurements are generally taken by instruments mounted within drill collars above the drill bit and may obtain information, such as the position of the drill bit, the nature of the drilling process, oil/gas composition/quality, pressure, temperature and other geophysical and geological conditions.

Downhole drilling and/or measurement tools may be provided with communication systems adapted to send signals, such as commands, power and information, between a downhole unit housed in the downhole tool, and a surface unit. Communication systems in drilling tools may include, for example, mud pulse systems that manipulate the flow of drilling mud through a downhole drilling tool to create pressure pulses. One such mud pulse system is disclosed in U.S. Pat. No. 5,517,464 and assigned to the present assignee, the entire contents of which are hereby incorporated by reference.

Wireless communication techniques, such as electromagnetic (or EMAG) telemetry systems, have also been employed in downhole drilling tools. Such systems include a downhole unit that creates an electromagnetic field capable of sending a signal to a remote surface unit. Examples of electromagnetic telemetry systems are disclosed in U.S. Pat. Nos. 5,642,051 and 5,396,232, both of which are assigned to the present assignee.

Advancements, such as the use of repeaters and gaps, have been implemented in existing drilling tools to improve the operability of electromagnetic systems in drilling applications. By creating a gap, or non-conductive insert, between adjoining sections of drillpipe, the electromagnetic field is magnified and provides an improved signal. Examples of a gap used in an electromagnetic telemetry system are described in U.S. Pat. No. 5,396,232, assigned to the present assignee, and U.S. Pat. No. 2,400,170 assigned to Silverman.

In some cases, such as deep well applications, mud pulse telemetry may be the best telemetry source. In other cases, such as high data rate, high rate of penetration conditions and poor quality mud conditions, electromagnetic telemetry may provide the best telemetry source. For example, electromagnetic telemetry is simple to set up and operate, but can be dependent on formation characteristics and have limited depth capability. In other cases, mud pulse telemetry tools may be capable of extreme depths, but may be sensitive to the mud conditions and require more expertise to operate.

In some cases, telemetry systems have also been made retrievable. For example, U.S. Pat. No. 6,577,244 describes a retrievable while drilling tool. Existing telemetry tools are typically housed in an expensive drill collar, designed specifically to couple with the telemetry tool. These expensive drill collars typically have an orientation feature at the bottom to orient the sensors relative to the drill collar and a telemetry sub, which facilitates the transmission of the information to the surface.

It is, therefore, desirable to provide a telemetry system that is adaptable to a variety of wellbore conditions. It is further desirable that such a system be convertible between different types of telemetry systems, and/or provide an efficient orientation system. Additional features may also be provided to enhance reliability, operational efficiency, power capability, size scalability, orientation and/or retrievability.

### SUMMARY OF THE INVENTION

The invention provides a telemetry system for a downhole tool positionable in a wellbore penetrating a subterranean formation. The system includes a telemetry tool engageable within the downhole tool. The telemetry tool comprising a telemetry unit, the unit being interchangeable between a mud pulse telemetry unit and an electromagnetic telemetry unit.

The invention provides a telemetry system for a downhole tool positionable in a wellbore penetrating a subterranean formation. The system includes a telemetry tool comprising an electromagnetic telemetry tool and a mud pulse telemetry tool, wherein the electromagnetic telemetry tool or the mud pulse telemetry tool may be individually disposed or retrieved from the telemetry tool when the tool is disposed in the wellbore.

The invention provides a method of disposing a telemetry system within a wellbore penetrating a subterranean formation. The method includes engaging a telemetry tool within a downhole tool for disposal in the wellbore, wherein the telemetry tool comprises a telemetry unit being interchangeable between a mud pulse telemetry unit and an electromagnetic telemetry unit; and selectively equipping the telemetry tool with a mud pulse telemetry unit or an electromagnetic telemetry unit when the downhole tool is disposed in the wellbore

### BRIEF DESCRIPTION OF THE DRAWINGS

These and other aspects and features of the present invention will become apparent to those of ordinary skill in the art upon review of the following description of specific embodiments of the invention in conjunction with the accompanying Figures, wherein:

FIG. 1 is a schematic illustration of a downhole tool suspended in a wellbore from a drilling rig via a drill string, the downhole tool provided with a telemetry tool in accordance with the teaching of the present invention;

FIG. 2A is a schematic illustration of one embodiment of an electromagnetic telemetry tool in accordance with the teachings of the present invention;

FIG. 2B is a schematic illustration of another embodiment of an electromagnetic telemetry tool in accordance with the teachings of the present invention;

FIG. 3A is a schematic illustration of one embodiment of a mud pulse telemetry tool in accordance with the teachings of the present invention;

FIG. 3B is a schematic illustration of another embodiment of a mud pulse telemetry tool in accordance with the teachings of the present invention;

FIG. 4A is a schematic illustration of a combination telemetry tool showing one embodiment of a hanger system in accordance with the teaching of the present invention; and

FIG. 4B is a schematic illustration of a combination telemetry tool showing another embodiment of a hanger system in accordance with the teaching of the present invention.

### DETAILED DESCRIPTION

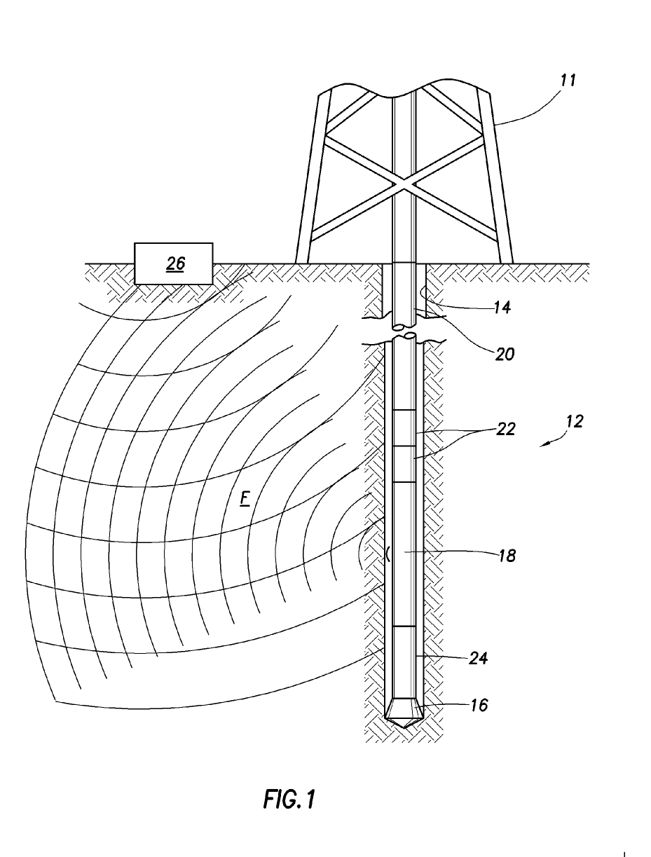

Referring now to FIG. 1, a rig 11 supports a downhole drilling tool 12 that is suspended from the rig 11 in a wellbore 14. The downhole tool 12 is adapted to drill the wellbore 14 using a drill bit 16 located at a lower end thereof. The downhole tool 12 is operatively connected to and includes a downhole telemetry tool 18 and a drill string 20. The drill string 20 includes a plurality of drill collars connected to form the drill string 20.

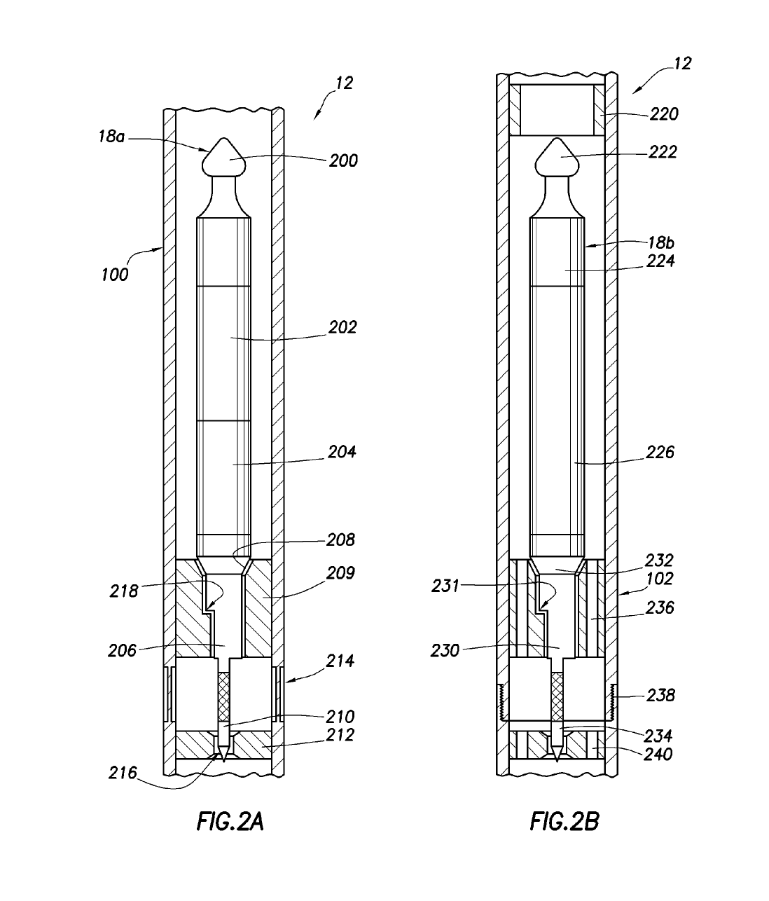

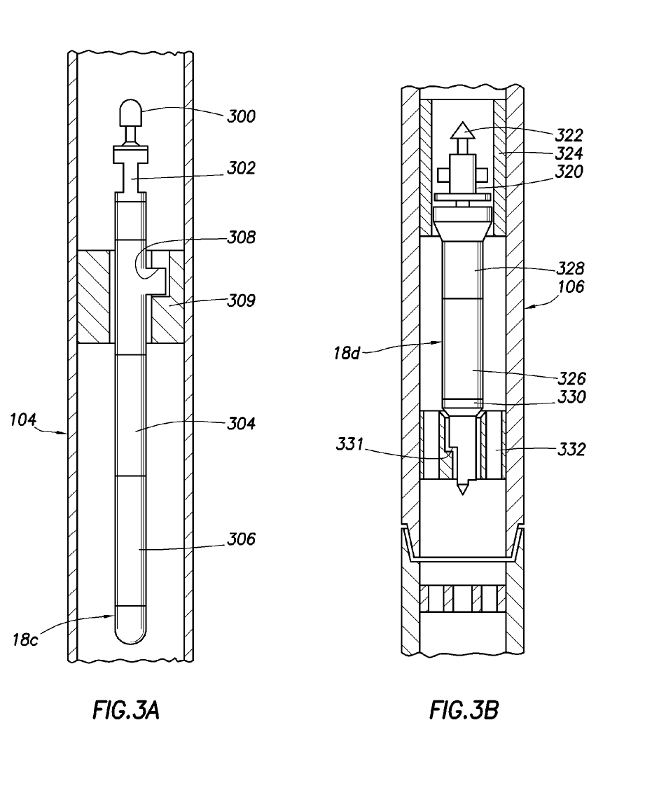

Various components, such as the telemetry tool 18, sensors 22, a power unit 24, as well as other components, are positioned in one or more drill collars and enable the downhole tool 12 to perform various downhole operations. The telemetry tool 18 may be an electromagnetic tool, as further described with respect to FIGS. 2A and 2B, that communicates with a surface detection unit 26 capable of detecting electromagnetic pulses, or a mud pulse tool, as further described with respect to FIGS. 3A and 3B, that communicates with a surface detection unit adapted to detect mud pulses, as described in detail below. Thus, in accordance with the teachings of the present invention, the telemetry tools of FIGS. 2 and 3 contain interchangeable modules. These interchangeable modules allow the telemetry tool 18 of FIG. 1 to be converted from an electromagnetic telemetry tool to a mud pulse telemetry tool (and vice versa). Furthermore, in accordance with the teaching of the present invention, the telemetry tool 18 of FIG. 1 can be adapted to include an electromagnetic telemetry tool and a mud pulse telemetry tool. Other telemetry tools, such as an acoustic tool may also be used. Additionally, these telemetry tools may be converted at the surface, or retrieved from downhole for conversion and then reinserted.

Referring now to FIG. 1 and FIG. 2A, a portion of the downhole tool 12 is shown wherein the telemetry tool 18 is an electromagnetic telemetry tool 18a. The electromagnetic tool 18a is operatively coupled, preferably via a wireless communication link, to the surface unit 26 (as shown in FIG. 1) for communication therebetween. The electromagnetic tool 18a generates an electromagnetic field F receivable by the surface unit 26. The electromagnetic tool 18a transmits the electromagnetic field F that carries the data collected in the downhole tool 12 to the surface unit 26. The surface unit 26 is also adapted to send an electromagnetic field receivable by the electromagnetic tool 18a.

The electromagnetic tool 18a is positioned within a collar system 100. The electromagnetic tool 18a includes a fishing head 200, a battery module 202, a control unit module 204 and a transmitter module 206. These modules may be contained in one or more drill collars, which form the collar system 100. Furthermore, the scope of the present invention is not limited by the relative positioning of the modules; the order of the modules can be altered as desired.

The fishing head 200 is positioned at an uphole end of the electromagnetic tool 18a. The fishing head 200 is configured to allow easy retrieval and insertion of the electromagnetic tool 18a. This is particularly useful when the drill collar system becomes stuck and the electromagnetic tool 18a needs to be retrieved before the drill collar system is abandoned. For retrieval, a conventional retrieval device is lowered down the center of the drill collar system or string and attached to the fishing head 200 as known in the art. The telemetry tool 18a can then be pulled to the surface for future use.

The battery module 202 includes one or more batteries, such as sequential depletion batteries, that can be used to provide power to the telemetry tool such as the electromagnetic tool 18a. The battery system is one mode of powering the tool electronics. In implementations, the most economical system can be employed. Numerous ways to create cost effective power systems include, but are not limited to, batteries with sequential depletion schemes and batteries with internal usage tracking circuits. Other modes are possible, including a turbine/alternator system driven by the drilling fluid flow as known in the art, such as a turbo-modulator.

The control unit module 204 houses the electronics used to operate the electromagnetic tool 18a. The electronics in the control unit module 204 are used to send and receive coded messages or data. The control unit module 204 may be configured with electronic circuitry and sensors specifically designed for high reliability. The sensors may be, for example, direction and inclination, gamma ray, resistivity, drilling dynamics or other measurement or logging while drilling sensors. Higher than typical design margins may be incorporated into the design in order to achieve significantly higher reliability. This can be accomplished by, but is not limited to, using Multi-Chip Module (MCM) electronic packaging technology.

The transmitter module 206 is used to generate the electromagnetic signals that are sent, as well as to detect electromagnetic signals. The transmitter module 206 includes an orienting device 208 that engages a landing device 209 of the collar system 100, a lower transmitter contact 210 that is positioned within a hole in a lower transmitter receptacle 212 and a non-metallic gap collar 214. The lower transmitter contact 210 is removably positionable in the lower transmitter receptacle 212. Preferably, the lower transmitter contact 210 has a tapered nose portion 216 to facilitate insertion into the transmitter receptacle 212. The gap collar 214 is non-conducting and enhances signal capabilities for the electromagnetic tool 18a.

The orienting device 208 has a keyway 218 adapted to abut against the landing device 209 and, hence, position the electromagnetic tool 18a within the collar system 100. The keyway 218 assists in aligning the electromagnetic tool 18a within the downhole tool 12. The combined orienting device 208 and landing device 209 form an integrated landing and orientation device that houses the tool-specific collar hardware in a shorter, less expensive collar system. The remainder of the telemetry tool 18a may then be housed in a low cost collar (e.g., a rental monel collar). The integrated device may then be positioned in a short insulated gap collar, such as the gap collar 214, for electromagnetic telemetry or in a short flow sub for mud pulse telemetry.

Referring now to FIG. 2B, an electromagnetic telemetry tool 18b is positioned within a collar system 102 and forms an alternative embodiment of the telemetry tool 18 of the downhole tool 12 of FIG. 1. The collar system 102 includes a flow sleeve 220 proximally positioned relative to a fishing head 222 of the electromagnetic tool 18b. In the present embodiment, the downhole tool 12 is a convertible downhole tool that can be adapted to include an electromagnetic telemetry tool, a mud pulse tool, or a combination telemetry tool, as discussed in detail below.

In one embodiment, the electromagnetic tool 18b includes a battery module 224 and a control module 226, each of which are operable in a fashion similar to the operations discussed above with respect to electromagnetic tool 18a. The electromagnetic tool 18b includes a transmitter unit 230 for sending and receiving electromagnetic signals. The transmitter unit 230 includes an orienting unit 232 and a transmitter contact 234. The orienting unit 232 has a keyway 231 that assists in aligning the electromagnetic tool 18b within the collar system 102. The keyway 231 of the orienting unit 232 engages a landing unit 236 in order to align the electromagnetic tool 18b. The transmitter contact 234 is positioned within a non-metallic gap collar 238 and retractably positioned within a transmitter receptacle 240. In a preferred embodiment, the transmitter contact 234 has a tapered nose portion. The gap collar 238 is provided to enhance signal capabilities for the electromagnetic tool 18b.

Referring now to FIG. 3A, a mud pulse telemetry tool 18c includes a fishing head 300, a transmitter module 302, a control unit module 304 and a battery module 306. These modules may be contained in one or more drill collars, such as the collar system 104. The fishing head 300 is positioned at an uphole end of the mud pulse tool 18c. The fishing head 300 is typically used to insert or retrieve the mud pulse tool 18c as known in the art.

The transmitter module 302 includes a mud pulse generator, such as the one described in U.S. Pat. No. 5,517,464. This transmitter may be provided with an orienting device 308 and corresponding landing device 309. Accordingly, the orientation device 308 is keyed to the landing device 309 of the collar system 104 for orientating the mud pulse tool 18c.

The control module 304 houses the electronics used to operate the mud pulse tool 18c. The electronics in the control module 304 are used to send mud pulse signals to a detection unit located at the surface as well as to detect mud pulse signals that are received from the surface. Conventional mud pulse hardware may be used to implement embodiments of the invention. The battery module 306 contains batteries used to provide power, as discussed with respect to tools 18a and 18b of FIGS. 2A and 2B, respectively. Such batteries may be for example, sequential depletion batteries.

Referring now to FIG. 3B a mud pulse telemetry tool 18d used within a common collar system 106 of the downhole tool 12 of FIG. 1 includes a pressure pulse generator unit 320 and a fishing head 322. The pulse unit 320 is proximally positioned within a flow sleeve 324 of the collar system 106. In the present embodiment, the downhole tool 12 is a convertible downhole tool that can be adapted to include an electromagnetic telemetry tool instead of or in addition to a mud pulse telemetry tool.

In one embodiment, the mud pulse tool 18d includes a battery module 326 and a control module 328, each of which have an operation similar to the operation discussed above with respect to the mud pulse tool 18c of FIG. 3A. In an alternative embodiment, the battery module is supplemented or replaced by a turbine unit that converts mud flow into electrical power and thereby provides power to the tool. Such a power generation unit can be used with any of the tool implementations disclosed herein. In some embodiments, the turbine unit may be included as part of the pulse unit 320 while in alternative embodiments, the turbine unit is a separate unit.

The mud pulse tool 18d includes an orienting unit 330 that includes a keyway 331. The keyway 331 of the orientation unit 330 engages a landing unit 332 of the collar system 106 in order to align the mud pulse tool 18d within the collar system 106.

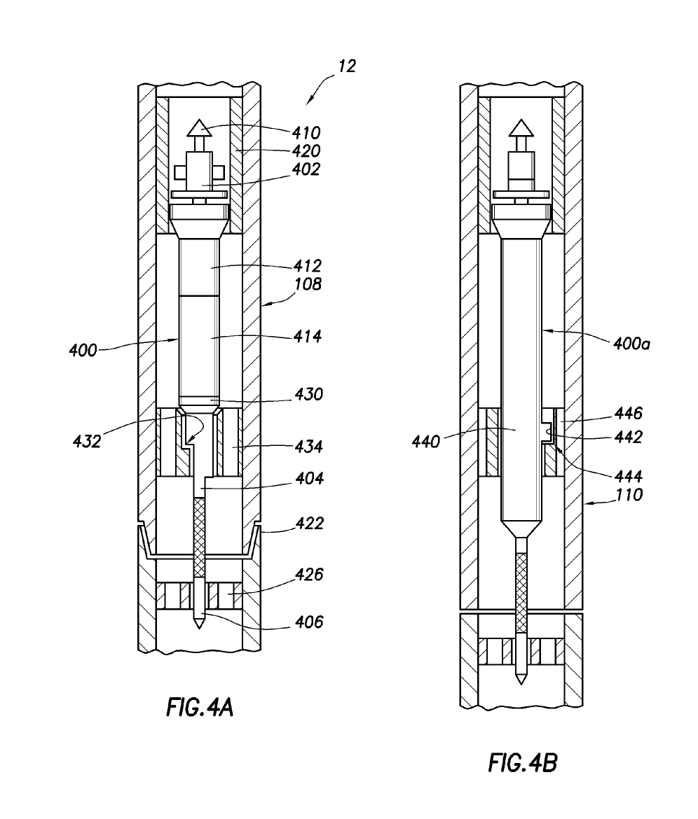

Referring now to FIG. 4A, a combination telemetry tool 400 includes a mud pulse telemetry unit 402 and an electromagnetic telemetry unit 404, each located at opposite ends of the telemetry tool 400. The telemetry tool 400 also includes a fishing head 410, a control module 412, and a battery module 414. The telemetry unit 402 of the telemetry tool 400 is positioned within a flow sleeve 420 of the collar system 108. The telemetry unit 404 includes a transmitter contact portion 406 that is positioned within a non-metallic gap collar 422 and movably located within a transmitter receptacle sleeve 426. As discussed above, the gap collar 422 is provided to enhance the electromagnetic signal.

The telemetry tool 400 includes an orientation unit 430 that is used to align the telemetry tool 400. The orientation unit 430 has a key 432 that is used to align the telemetry tool 400 in a precise orientation as the key 432 is aligned with a corresponding key-slot in a landing sleeve 434 of the collar system 108.

Referring now to FIG. 4B, a telemetry tool 400a, similar in function to the telemetry tool 400 of FIG. 4A, is shown with an alternative orientation unit 440. The orientation unit 440 is shown to include a load-bearing key 442 positioned within a corresponding notch 444 of a hanger sleeve 446. As the telemetry tool 400a is lowered within a collar system 110, the key 442 is aligned with the notch 444 of the hanger sleeve 446 and, hence, the telemetry tool 400a is accurately aligned and securely positioned within the collar system 110 that is part of the downhole tool 12.

With respect to FIGS. 2A and 3A, the telemetry tools 18a and 18c are preferably interchangeable. The downhole tool 12 of FIG. 1 may be provided with an electromagnetic tool, such as the electromagnetic tool 18a of FIG. 2A. The electromagnetic tool 18a may then be removed and replaced with the mud pulse tool 18c of FIG. 3A. This is achieved by retrieving the electromagnetic tool 18a and replacing certain modules. For example, the transmitter module 206 of the electromagnetic tool 18a is replaced with the transmitter module 302 of the mud pulse tool 18c. In the present example, each of the control units 204 and 304 has sufficient electronics and control systems capable of performing with either the mud pulse telemetry tool or electromagnetic telemetry tool. In this manner, the dowhole tool 12 may be converted between electromagnetic and mud pulse telemetry without retrieving the entire downhole tool 12. Thus, by way of example, when the depth limits of an electromagnetic telemetry tool are reached, the downhole tool may be converted to a mud pulse telemetry tool by removing the electromagnetic transmitter module 206 of the electromagnetic telemetry tool 18a and attaching the mud pulse telemetry transmitter 302 of the mud pulse telemetry tool 18c. Even though the present example discusses removal and replacement of certain portions of the tool 18, it is within the scope of present invention to remove one tool and replace it with a new tool, instead of changing certain modules.

With respect to FIGS. 2B and 3B, the telemetry tools 18b and 18d are preferably interchangeable. The downhole tool 12 of FIG. 1 may be provided with an electromagnetic tool, such as the electromagnetic tool 18b of FIG. 2B. The electromagnetic tool 18b may then be removed and replaced with the mud pulse tool 18d of FIG. 3B. This is achieved by retrieving the electromagnetic tool 18b and replacing certain modules. For example, the transmitter module 224 of the electromagnetic telemetry tool 18b is replaced with the transmitter module 328 of the mud pulse telemetry tool 18d. In this manner, the dowhole tool 12 may be converted between electromagnetic and mud pulse telemetry without retrieving the entire downhole tool 12. Thus, by way of example, when the depth limits of an electromagnetic telemetry tool are reached, the tool may be converted to a mud pulse telemetry tool by removing the electromagnetic transmitter module 224 of the electromagnetic telemetry tool 18b and attaching the mud pulse telemetry transmitter 328 of the mud pulse telemetry tool 18d.

With respect to FIGS. 4A and 4B, a combination tool is deployed, thereby allowing the downhole tool 12 to communicate information to a remote location using electromagnetic telemetry and/or mud pulse telemetry. The desired telemetry may be determined depending on downhole conditions and the depth of the downhole tool.

The control systems or control units used herein are preferably provided with automated software capable of automatically performing downhole functions. Various processors or other downhole systems may be provided for use alone or in conjunction with surface systems and the scope of the present invention is not limited thereby. Manual systems may also be provided to activate the tool operations.

While FIGS. 1-4 depict various configurations of a convertible or combination telemetry system, the order in which the components are depicted does not limit the scope of the invention. Each of the modules depicted may be re-arranged for a variety of configurations. For example, the transmitter in the electromagnetic telemetry tool may be at the bottom to allow transmission from the tool in quick response to the time the tool exits the casing, for example, or as early as possible in the drilling process.

While this invention has been described with references to various illustrative embodiments, the description is not intended to be construed in a limiting sense. Various modifications and combinations of the illustrative embodiments, as well as other embodiments of the invention, will be apparent to persons skilled in the art upon reference to the description.

What is claimed is:

1. A telemetry system for a downhole tool positionable in a wellbore penetrating a subterranean formation, comprising:
a telemetry tool engageable within the downhole tool; and
the telemetry tool comprising a telemetry unit, the unit being interchangeable between a mud pulse telemetry unit and an electromagnetic telemetry unit.

2. The telemetry system of claim 1 wherein the telemetry tool is retrievable from the downhole tool to the surface for interchanging between a mud pulse and electromagnetic telemetry unit.

3. The telemetry system of claim 1 wherein the telemetry unit is retrievable from the downhole tool to the surface for replacement of the telemetry unit.

4. The telemetry system of claim 3 wherein the telemetry unit is replaceable with one of a mud pulse telemetry unit and an electromagnetic telemetry unit.

5. The telemetry system of claim 1 wherein the telemetry unit is interchangeable between a mud pulse and electromagnetic telemetry unit when the telemetry tool is disposed in the wellbore.

6. The telemetry system of claim 1 further comprising a fishing head for retrieval of the telemetry tool to the surface.

7. The telemetry system of claim 1 further comprising a control unit for operating the telemetry tool.

8. The telemetry system of claim 1 further comprising a power source for providing power to the telemetry tool.

9. The telemetry system of claim 1 further comprising a sensor unit for taking downhole measurements.

10. The telemetry system of claim 1 further comprising a landing device within the downhole tool to receive the telemetry tool.

11. The telemetry system of claim 1 wherein the telemetry tool comprises a plurality of telemetry units.

12. The telemetry system of claim 11 wherein the telemetry tool comprises a control unit for selectively operating the telemetry units.

13. The telemetry system of claim 1 further comprising a surface unit for communicating with the telemetry tool.

14. A telemetry system for a downhole tool positionable in a wellbore penetrating a subterranean formation, comprising:
a telemetry tool comprising an electromagnetic telemetry tool and a mud pulse telemetry tool;
wherein the electromagnetic telemetry tool or the mud pulse telemetry tool may be individually disposed or retrieved from the telemetry tool when the tool is disposed in the wellbore.

15. A method of disposing a telemetry system within a wellbore penetrating a subterranean formation, comprising:
engaging a telemetry tool within a downhole tool for disposal in the wellbore, wherein the telemetry tool comprises a telemetry unit being interchangeable between a mud pulse telemetry unit and an electromagnetic telemetry unit; and
selectively equipping the telemetry tool with a mud pulse telemetry unit or an electromagnetic telemetry unit when the downhole tool is disposed in the wellbore.

16. The method of claim 15, wherein the telemetry tool is disposed to engage within the downhole tool when the downhole tool is in the wellbore.

17. The method of claim 15, wherein the telemetry tool comprises a mud pulse telemetry unit and an electromagnetic telemetry unit.

18. The method of claim 15, further comprising retrieving the telemetry tool to the surface of the wellbore and interchanging the mud pulse telemetry unit or the electromagnetic telemetry unit on the telemetry tool without retrieving the downhole tool from the wellbore.
